(19) United States
(12) Patent Application Publication
(10) Pub. No.: US 2021/0036537 A1
(43) Pub. Date: Feb. 4, 2021

(54) MULTIFUNCTIONAL WIRELESS CHARGER

(71) Applicant: SHENZHEN RUINENG WIRELESS TECHNOLOGY CO., LTD., Shenzhen (CN)

(72) Inventors: JIANLONG YANG, Ji'AN (CN); JUN YANG, Ji'AN (CN)

(21) Appl. No.: 16/575,376

(22) Filed: Sep. 18, 2019

(30) Foreign Application Priority Data
Aug. 1, 2019 (CN) 201910720388.5

(51) Int. Cl. H02J 7/02; H02J 7/00; H01R 31/06; H01R 33/05; H01R 33/90; H01R 33/945

(52) U.S. Cl. CPC H02J 7/025; H02J 7/0045; H02J 7/0052; H02J 2007/0062; H01R 33/05; H01R 33/90; H01R 33/945; H01R 31/06

(57) ABSTRACT

A multifunctional wireless charger comprises a housing, inside which a circuit board, a portable power source connected therewith, and three or more charging coils are arranged; the charging coils are fixed on the inner side wall of the housing, on which is arranged a plug-in part connected with the circuit board; the plug-in part is further connected with an external power source for supplying power to the charging coils, so that an electronic product can be charged after being attached to the outer side wall of the housing. The charger is provided with more than three charging coils and can charge at least three electronic products with wireless charging function at the same time; moreover, the charger can be connected with a USB cable to charge electronic products without wireless charging function. Therefore, the charger is convenient to use without a USB cable.

### TECHNICAL FIELD

The invention relates to the technical field of chargers, in particular to a multifunctional wireless charger.

### BACKGROUND

Nowadays, the prevalence of electronic products has brought a lot of convenience to our life and everyone is basically accustomed to using electronic products. Thus, it is inevitable for them to charge electronic products frequently. It can be seen that chargers for charging electronic products play an increasingly important role. In order to make charging electronic products more and more convenient, chargers are constantly updated to wireless chargers, multi-interface chargers and so on. However, existing chargers mostly have simple function and are equipped with a power cord, and one charger cannot meet users' needs for charging more than one appliance at the same time. For example, when traveling, one needs to charge not only mobile phones but also watches, laptops and other electronic products. If one charger and charging cable are carried for each electronic product, it will be very troublesome, which is an urgent problem to be solved at present.

### SUMMARY OF THE INVENTION

The purpose of the invention is to provide a multifunctional wireless charger, aiming at solving the technical problem in the prior art.

In order to solve the technical problems above, the technical scheme of the invention is to provide a multifunctional wireless charger, comprising a housing, inside which a circuit board, a portable power source connected therewith, and three or more charging coils are arranged; the charging coils are fixed on the inner side wall of the housing, a plug-in part connected with the circuit board is arranged on the housing, the plug-in part is connected with an external power source for supplying power to the charging coils, and electronic products are attached to the outer side wall of the housing for charging.

Preferably, the housing is a cuboid as a whole, the charging coils have three charging coils, and the three charging coils are respectively installed on the inner sides of three sides of the housing, and the plug-in part is connected with an external power source for charging electronic products attached to the three sides at the same time.

Preferably, the housing is a cuboid as a whole, the common sides of two adjacent sides of the housing form a chamfered surface, and the chamfered surface is provided with a magnetic adsorbing sheet for adsorbing electronic products; the charging coils have three charging coils, and the three charging coils are respectively installed on the inner side walls of the two adjacent sides and the chamfered surface, and the plug-in part is connected with an external power source for charging electronic products attached to the two adjacent sides and the chamfered surface at the same time.

Preferably, the plug-in part comprises a first contact module arranged on the housing and connected with the circuit board, and a second contact module connected with the first contact module and detachably connected with the housing; and the second contact module is connected with an external power source for supplying power to the circuit board through the first contact module.

Preferably, the first contact module comprises an electric jack arranged on the housing, and a first electrode needle connected with the circuit board is fixed in the electric jack; the second contact module comprises a holder, a second electrode needle and an electrical plug arranged thereon; when the second contact module is installed on the housing, the second electrode needle is inserted into the electric jack to contact the first electrode needle, and the electrical plug is inserted into the external power socket for supplying power to the circuit board.

Preferably, the first contact module comprises a first electrode slice arranged on the housing and connected with the circuit board; the second contact module comprises a holder, a second electrode slice and an electrical plug arranged thereon; when the second contact module is installed on the housing, the first electrode slice is in contact with the second electrode slice, and the electrical plug is inserted into an external power socket for supplying power to the circuit board.

Preferably, the electrical plug comprises a two-pin plug or a three-pin plug, and the two-pin plug can be accommodated in the holder.

Preferably, the housing is further provided with a charging indicator connected with the circuit board.

Preferably, the housing is further provided with a USB interface or a charging port connected with the circuit board.

Preferably, the housing is further provided with a switch button connected with the circuit board.

Based on the technical scheme, the beneficial effects are as follows: the charger of the invention is provided with more than three charging coils and can charge at least three electronic products with wireless charging function at the same time; moreover, the charger can be connected with a USB cable to charge electronic products without wireless charging function. Therefore, the charger is convenient to use without a USB cable; meanwhile, it is not provided with a power cord and thus can be carried conveniently.

### BRIEF DESCRIPTION OF THE DRAWINGS

FIG. 1 is a perspective view of Example 1 of the invention;

FIG. 2 is a perspective view from an angle of Example 2 of the invention;

FIG. 3 is a perspective view from another angle of Example 2 of the invention;

FIG. 4 is a use state diagram of Example 2 of the invention;

FIG. 5 is another use state diagram of Example 2 of the invention;

FIG. 6 is a schematic structural diagram of a plug-in part according to Example 1 of the invention;

FIG. 7 is a schematic structural diagram of a plug-in part according to Example 2 of the invention;

In the figure, 1. housing; 2. plug-in part; 3. electrical plug; 4. USB interface; 5. charging port; 6. first charging surface; 7. second charging surface; 8. third charging surface; 9. magnetic absorbing sheet; 10. electrical quantity indicator; 11. charging indicator; 12, switch button; 13. electric jack; 14. second electrode needle; 15. first electrode slice; 16. second electrode slice; 17, buckle; 18, slot.

### DETAILED DESCRIPTION OF THE PREFERRED EMBODIMENT

The invention will be further described in detail in combination with drawings. It should be noted that the description of these embodiments is used to help understand the invention, but not improperly limit thereto. In addition, the technical features involved in various embodiments of the invention described below can be combined with each other as long as they do not constitute conflicts with each other.

The embodiment provides a multifunctional wireless charger, comprising a housing 1, inside which a circuit board, a portable power source connected therewith, and three or more charging coils are arranged. The charging coils are fixed on the inner side wall of the housing 1, a plug-in part 2 connected with the circuit board is arranged on the housing 1, the plug-in part 2 is connected with an external power source for supplying power to the charging coils, and electronic products can be charged after being attached to the outer side wall of the housing 1.

The invention has the main advantages as follows: a plurality of electronic products with wireless charging functions can be charged at the same time, the charging lines can be plugged in and connected with the USB interface 4 to charge the electronic products without wireless charging functions, the portable power source arranged in the housing 1 can enable the charger to supply power to the charging coil even through it is not plugged in an external power source, and the charger can be used for the charging purpose in case of power failure or outdoors; and the plug for the plug-in part 2 may be of various types, for example, a two-core or three-pin type.

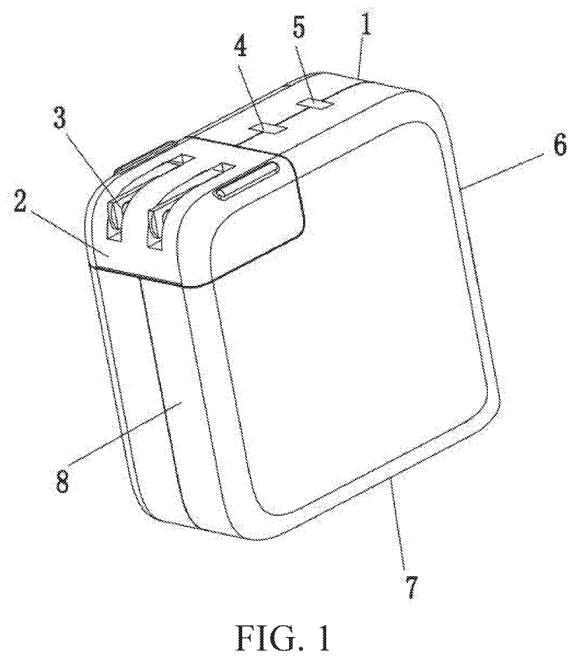

Example 1 of the invention is shown in FIG. 1.

In particular, the housing 1 is a cuboid as a whole, three charging coils are respectively installed on the inner sides of the three sides of the housing 1, and the plug-in part 2 is connected with an external power source for charging electronic products attached to the three sides at the same time. The three charging coils are respectively attached to the inner sides of the first charging surface 6, the second charging surface 7 and the third charging surface 8, and are arranged inside the housing 1. When the insertion core of the plug-in part 2 is connected with an external power source, the three charging coils will be energized to charge electronic products attached to the outer sides of the first charging surface 6, the second charging surface 7 and the third charging surface 8. The charging lines can also be inserted into the USB interface 4 of the housing 1 to charge an electronic product without wireless charging function, such as a computer.

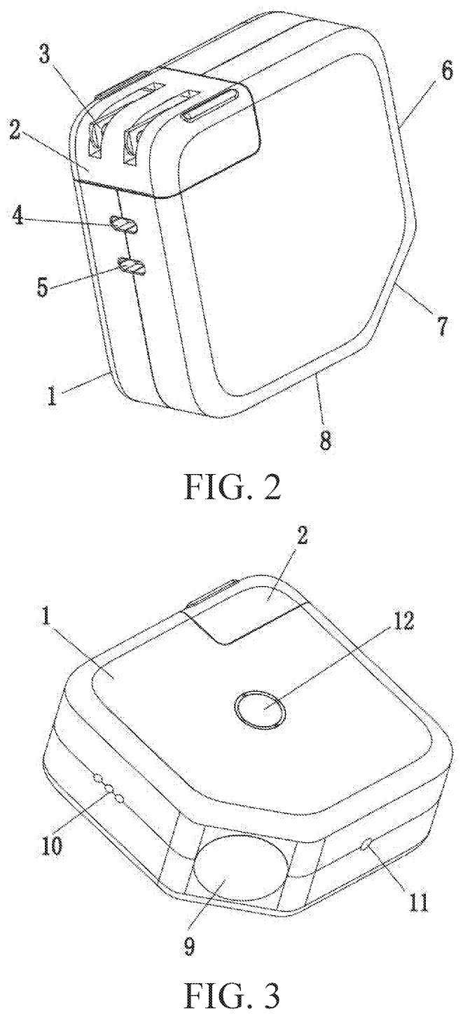

Example 2 of the invention is shown in FIG. 2 and FIG. 3.

The housing 1 is a cuboid as a whole, the common sides of two adjacent sides of the housing 1 form a chamfered surface, and the chamfered surface is provided with a magnetic adsorbing sheet 9 for adsorbing electronic products. Three charging coils are respectively installed on the inner side walls of the two adjacent sides and the chamfered surface, and the plug-in part 2 is connected with an external power source for charging electronic products attached to the two adjacent sides and the chamfered surface at the same time. The magnetic absorbing sheet 9 can absorb electronic products (e.g. watches, bracelets and the like) with metal parts and charge them on chamfered surfaces. In addition, the other two adjacent sides can simultaneously charge the attached electronic products, such as mobile phones and earphones, and allow plugging charging lines into the USB interface 4 of the housing 1 to charge an electronic product without wireless charging function, such as a computer.

The wireless charger of the invention may be provided with four or five charging coils. In the embodiments involving four charging coils, the three charging coils are provided on the first charging surface 6, the second charging surface 7 and the third charging surface 8 respectively; moreover, one charging coil is provided on the front or the back of the housing 1. In the embodiments involving five charging coils, both the front and the back of the housing are provided with one charging coil. From the perspective of cost and practicability, three or four charging coils are generally provided, while five charging coils are not common. In order to use a charger as long as possible, it is generally impractical to charge too many electronic products at the same time; otherwise, the circuit board will be overloaded, resulting in shortening of its service life.

The wireless charger has two common working conditions:

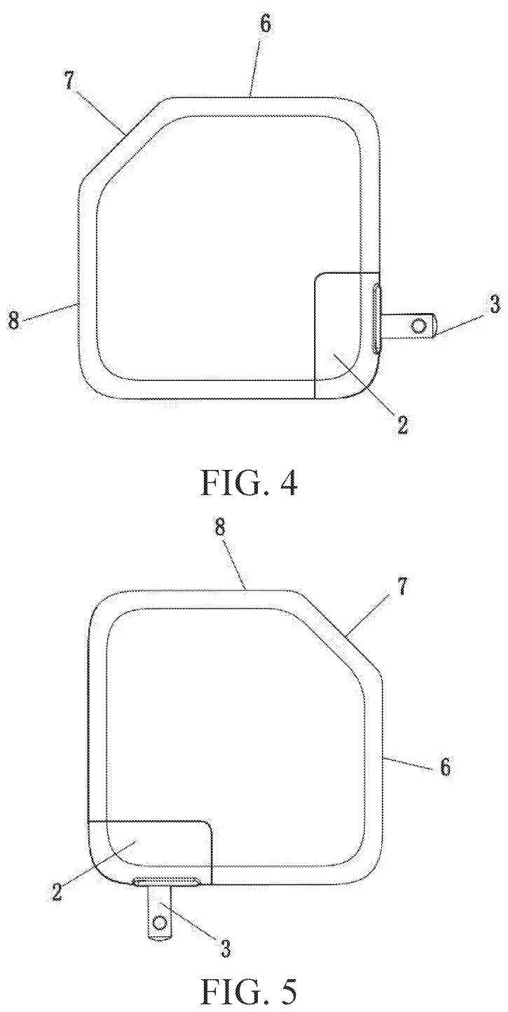

FIG. 4 shows a wall-plugged charging type. In particular, the plug-in part 2 is plugged into a wall-mounted power socket, the charging coils arranged on the first charging surface 6, the second charging surface 7 and the third charging surface 8 are powered on. Then, the first charging surface 6 and the second charging surface 7 can be used for charging, but the third charging surface 8 is generally not used for charging since it is perpendicular to the ground. For the charging purpose, a mobile phone can be placed on the first charging surface 6, a watch with metal parts and wireless charging function can be adsorbed on the second charging surface 7, and the USB interface 4 on the charger housing can also be connected with a charging cord to charge electronic products such as a laptop and a mobile phone.

FIG. 5 shows a desktop charging type. In particular, the plug-in part 2 is plugged into a power socket arranged on the desktop so that the second charging surface 7 and the third charging surface 8 can be used for charging. However, the first charging surface 6 is generally not used for charging since it is perpendicular to the ground. For the charging purpose, a mobile phone can be placed on the third charging surface 8, a watch with metal parts and wireless charging function can be adsorbed on the second charging surface 7, and the USB interface 4 on the charger housing can also be connected with a charging cord to charge electronic products such as a laptop and a mobile phone.

The plug-in part 2 and the housing 1 are connected and powered on in two ways:

The plug-in part 2 comprises a first contact module arranged on the housing 1 and connected with a circuit board, and a second contact module connected with the first contact module and detachably connected with the housing 1, wherein the second contact module is connected with an external power source to feed the circuit board through the first contact module.

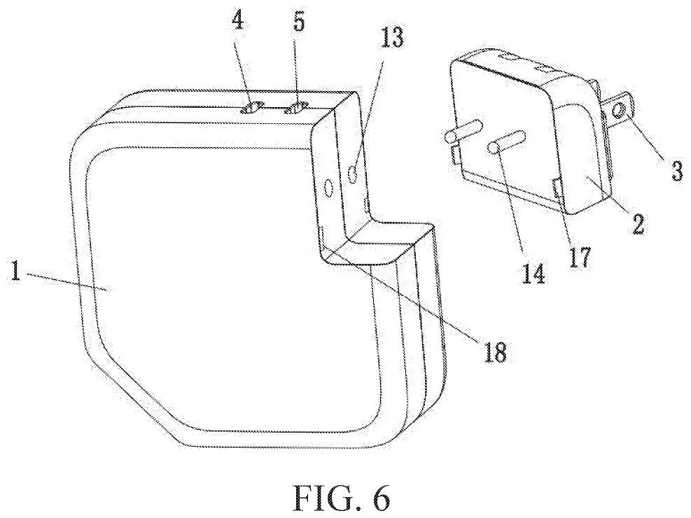

As shown in FIG. 6, the first contact module comprises an electric jack 13 arranged on the housing 1, a first electrode needle connected with the circuit board is fixed in the electric jack 13, and the first electrode needle is arranged in the electric jack 13. The second contact module comprises a holder, a second electrode needle 14 and an electrical plug 3 arranged thereon, and the electrical plug 3 is connected with the second electrode needle 14. When the second contact module is installed on the housing 1, the second electrode needle 14 is inserted into the electric jack 13 to contact the first electrode needle, and the electrical plug 3 is inserted into the external power socket for supplying power to the circuit board, thus supplying power to the charging coil to charge the electronic products. Buckles 17 are installed on both sides of the holder, and are in fit connection with the slot 18 arranged on the housing 1 to enable the holder to be installed and fixed on the housing 1.

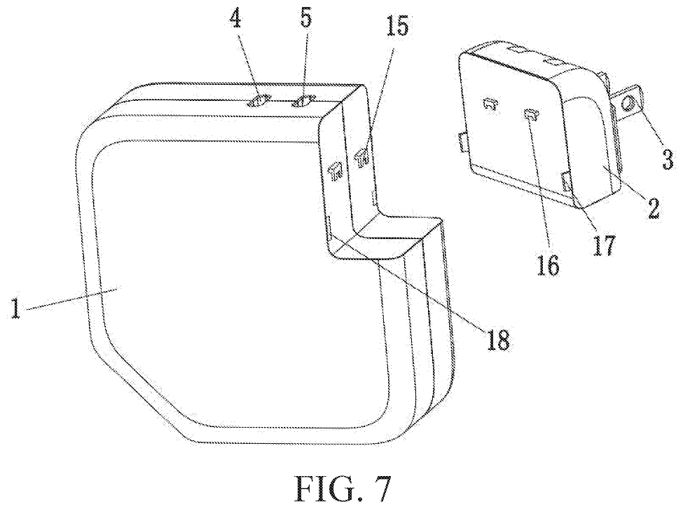

As shown in FIG. 7, the first contact module comprises a first electrode slice 15 arranged on the housing 1 and connected with the circuit board, and the second contact module comprises a holder, a second electrode slice 16 and an electrical plug 3 arranged thereon, and the electrical plug 3 is connected with the second electrode slice 16. When the second contact module is installed on the housing 1, the first electrode slice 15 is in contact with the second electrode slice 16, and the electrical plug 3 is inserted into the external power socket for supplying power to the circuit board, thus supplying power to the charging coil to charge the electronic products. Buckles 17 are installed on both sides of the holder, and are in fit connection with the slot 18 arranged on the housing 1 to enable the holder to be installed and fixed on the housing 1.

The electrical plug 3 comprises a two-pin plug or a three-pin plug, and the two-pin plug can be accommodated in the holder. US, AU and EU type plugs are mostly used as two-pin plugs, and UK-type plugs are used as three-pin plugs. The holder is further provided with a plug contact which is connected with the second electrode slice 16 or the second electrode needle 14. When the two-pin plug is accommodated in the holder, the plug contact is not in contact with the second electrode slice 16 or the second electrode needle 14. When the two-pin plug is rotated and extends out of the holder to keep vertical, the plug contact is in contact with the second electrode slice 16 or the second electrode needle 14. The pins of the three-pin plug are fixedly connected with the second electrode piece 16 or the second electrode needle 14.

The housing 1 is further provided with a charging indicator 11 connected with the circuit board. When the charging coil normally charges an electronic product, the charging indicator 11 flashes green several times and then goes out. In case of abnormal charging, it will always be displayed in red. The electric quantity indicator 10 arranged on the housing 1 is connected with the circuit board for displaying the remaining electric quantity of the built-in portable power source to prompt the user whether charging is required.

The housing 1 is further provided with a USB interface 4 or a charging port 5 connected with the circuit board. The charging line is plugged in the USB interface 4 to charge electronic products without wireless charging function, and the charging port 5 is used to connect a power cord to charge a portable power source while supplying power to a circuit board through an external power source.

The housing 1 is further provided with a switch button 12 connected with the circuit board. The switch button 12 is used to control the connection between the circuit board and the charging coil, and to control whether the charging coil charges electronic products.

The embodiments of the invention have been described in detail above in combination with the accompanying drawings, but the invention is not limited to the described embodiments. It will be apparent to those skilled in the art that various changes, modifications, substitutions and variations made to these embodiments without departing from the principles and spirit of the invention, still fall within the scope of protection of the invention.

1. A multifunctional wireless charger, comprising a housing, inside which a circuit board, a portable power source connected therewith, and three or more charging coils are arranged, wherein the charging coils are fixed on the inner side wall of the housing, on which is arranged a plug-in part connected with the circuit board; the plug-in part is further connected with an external power source for supplying power to the charging coils, so that an electronic product can be charged after being attached to the outer side wall of the housing.

2. The multifunctional wireless charger according to claim 1, wherein the housing is a cuboid as a whole, the charging coils have three charging coils, and the three charging coils are respectively installed on the inner sides of three sides of the housing, and the plug-in part is connected with an external power source for charging electronic products attached to the three sides at the same time.

3. The multifunctional wireless charger according to claim 1, wherein the housing is a cuboid as a whole, the common sides of two adjacent sides of the housing form a chamfered surface, and the chamfered surface is provided with a magnetic adsorbing sheet for adsorbing electronic products; the charging coils have three charging coils, and the three charging coils are respectively installed on the inner side walls of the two adjacent sides and the chamfered surface, and the plug-in part is connected with an external power source for charging electronic products attached to the two adjacent sides and the chamfered surface at the same time.

4. The multifunctional wireless charger according to claim 1, wherein the plug-in part comprises a first contact module arranged on the housing and connected with the circuit board, and a second contact module connected with the first contact module and detachably connected with the housing; and the second contact module is connected with an external power source for supplying power to the circuit board through the first contact module.

5. The multifunctional wireless charger according to claim 2, wherein the plug-in part comprises a first contact module arranged on the housing and connected with the circuit board, and a second contact module connected with the first contact module and detachably connected with the housing; and the second contact module is connected with an external power source for supplying power to the circuit board through the first contact module.

6. The multifunctional wireless charger according to claim 3, wherein the plug-in part comprises a first contact module arranged on the housing and connected with the circuit board, and a second contact module connected with the first contact module and detachably connected with the housing; and the second contact module is connected with an external power source for supplying power to the circuit board through the first contact module.

7. The multifunctional wireless charger according to claim 4, wherein the first contact module comprises an electric jack arranged on the housing, and a first electrode needle connected with the circuit board is fixed in the electric jack; the second contact module comprises a holder, a second electrode needle and an electrical plug arranged thereon; when the second contact module is installed on the housing, the second electrode needle is inserted into the electric jack to contact the first electrode needle, and the electrical plug is inserted into the external power socket for supplying power to the circuit board.

8. The multifunctional wireless charger according to claim 5, wherein the first contact module comprises an electric jack arranged on the housing, and a first electrode needle connected with the circuit board is fixed in the electric jack; the second contact module comprises a holder, a second electrode needle and an electrical plug arranged thereon; when the second contact module is installed on the housing, the second electrode needle is inserted into the electric jack to contact the first electrode needle, and the electrical plug is inserted into the external power socket for supplying power to the circuit board.

9. The multifunctional wireless charger according to claim 6, wherein the first contact module comprises an electric jack arranged on the housing, and a first electrode needle connected with the circuit board is fixed in the electric jack; the second contact module comprises a holder, a second electrode needle and an electrical plug arranged thereon; when the second contact module is installed on the housing, the second electrode needle is inserted into the electric jack to contact the first electrode needle, and the electrical plug is inserted into the external power socket for supplying power to the circuit board.

10. The multifunctional wireless charger according to claim 4, wherein the first contact module comprises a first electrode slice arranged on the housing and connected with the circuit board; the second contact module comprises a holder, a second electrode slice and an electrical plug arranged thereon; when the second contact module is installed on the housing, the first electrode slice is in contact with the second electrode slice, and the electrical plug is inserted into an external power socket for supplying power to the circuit board.

11. The multifunctional wireless charger according to claim 5, wherein the first contact module comprises a first electrode slice arranged on the housing and connected with the circuit board; the second contact module comprises a holder, a second electrode slice and an electrical plug arranged thereon; when the second contact module is installed on the housing, the first electrode slice is in contact with the second electrode slice, and the electrical plug is inserted into an external power socket for supplying power to the circuit board.

12. The multifunctional wireless charger according to claim 6, wherein the first contact module comprises a first electrode slice arranged on the housing and connected with the circuit board; the second contact module comprises a holder, a second electrode slice and an electrical plug arranged thereon; when the second contact module is installed on the housing, the first electrode slice is in contact with the second electrode slice, and the electrical plug is inserted into an external power socket for supplying power to the circuit board.

13. The multifunctional wireless charger according to claim 7, wherein the electrical plug comprises a two-pin plug or a three-pin plug, and the two-pin plug can be accommodated in the holder.

14. The multifunctional wireless charger according to claim 8, wherein the electrical plug comprises a two-pin plug or a three-pin plug, and the two-pin plug can be accommodated in the holder.

15. The multifunctional wireless charger according to claim 9, wherein the electrical plug comprises a two-pin plug or a three-pin plug, and the two-pin plug can be accommodated in the holder.

16. The multifunctional wireless charger according to claim 10, wherein the electrical plug comprises a two-pin plug or a three-pin plug, and the two-pin plug can be accommodated in the holder.

17. The multifunctional wireless charger according to claim 11, wherein the electrical plug comprises a two-pin plug or a three-pin plug, and the two-pin plug can be accommodated in the holder.

18. The multifunctional wireless charger according to claim 1, wherein the housing is further provided with a charging indicator connected with the circuit board.

19. The multifunctional wireless charger according to claim 1, wherein the housing is further provided with a USB interface or a charging port connected with the circuit board.

20. The multifunctional wireless charger according to claim 1, wherein the housing is further provided with a switch button connected with the circuit board.
